(19) United States
(12) Patent Application Publication
(10) Pub. No.: US 2013/0091558 A1
(43) Pub. Date: Apr. 11, 2013

(54) METHOD AND SYSTEM FOR SHARING MULTIMEDIA CONTENTS BETWEEN DEVICES IN CLOUD NETWORK

(71) Applicants: Hong-soo KIM, Seoul (KR); Hong-uk WOO, Seoul (KR); Sung-jin PARK, Yongin-si (KR); Pratap Shobhit SINGH, Suwon-si (KR)

(72) Inventors: Hong-soo KIM, Seoul (KR); Hong-uk WOO, Seoul (KR); Sung-jin PARK, Yongin-si (KR); Pratap Shobhit SINGH, Suwon-si (KR)

(73) Assignee: SAMSUNG ELECTRONICS CO., LTD., Suwon-si (KR)

(21) Appl. No.: 13/447,783

(22) Filed: Apr. 16, 2012

(30) Foreign Application Priority Data
Oct. 6, 2011 (KR) 10-2011-0101834

(51) Int. Cl. G06F 15/173; G06F 21/00; H04L 9/32

(52) U.S. Cl. 726/7; 709/225

(57) ABSTRACT

A method and system for sharing contents between devices registered in a cloud system. A cloud server in the cloud system includes a web server for controlling access of a first device to the cloud server; a cloud control unit for controlling networking between devices registered in the cloud server and a content server having access to the cloud server; a device management unit for managing information regarding the first device and the registered devices; and a context recognition management unit for managing context information of the first device and the registered devices.

### CROSS-REFERENCE TO RELATED PATENT APPLICATION

This application claims the benefit of Korean Patent Application No. 10-2011-0101834, filed on Oct. 6, 2011, in the Korean Intellectual Property Office, the disclosure of which is incorporated herein in its entirety by reference.

### BACKGROUND

1. Field

The exemplary embodiments relate to a method and system for sharing multimedia contents between devices in a cloud network, and more particularly, to a method and system for sharing multimedia contents by using user context information between devices having access to a cloud network.

2. Description of the Related Art

Currently, with the development of ultra high speed Internet technologies and communication technologies, web contents such as videos, images, and text data are shared by a plurality of users on a conventional web page or a web document in a user-desired format of multimedia data including multimedia contents as well as a simple data format. In other words, users share more and more web contents on the web by posting them to personal blogs or sharing them via social network service (SNS) sites.

Currently introduced cloud computing is an Internet-based computing technology, and is a computing style for providing information technology (IT)-related functions in the form of services. In a cloud computing environment, users may use Internet services even when they do not have professional knowledge regarding a technical infra structure or do not know about a control method. In general cloud computing, software, and data are stored in a server and are generalized concepts associated with technical trends such as Web 2.0 and Software as a Service (SaaS). A common feature of the concepts is to use the Internet to satisfy computing demands of users. Google Apps is an example. In the structure of a computer network, the Internet is represented as a cloud. In this case, the cloud refers to a hidden complicated infrastructure. Users may use cloud computing even when they have no knowledge about the complicated infrastructure of the cloud.

### SUMMARY

According to an aspect of the exemplary embodiments, there is provided a cloud server including a web server for controlling access of a first device to the cloud server; a cloud control unit for controlling networking between devices registered in the cloud server and a content server having access to the cloud server; a device management unit for managing information regarding the first device and the registered devices; and a context recognition management unit for managing context information regarding the first device and the registered devices.

According to another aspect of the exemplary embodiments, there is provided a device accessible to a cloud server, the device including an access unit for controlling access to the cloud server and a content server; and a reproduction unit for reproducing contents received from the content server, wherein the accessible device is one of devices registered in the cloud server, and wherein the contents include a list of devices having access to and detected by the cloud server from among the registered devices, and information regarding functions provided by the detected devices, and the contents are received by the access unit.

According to another aspect of the exemplary embodiments, there is provided a device accessible to a cloud server, the device including a control unit for controlling access to the cloud server and a content server; and a reproduction unit for reproducing information regarding contents received from the cloud server and the contents received from the content server based on a selection of at least one of devices accessible to the cloud server by a user, wherein the accessible device is one of devices registered in the cloud server, and wherein the information regarding the contents is transmitted from the content server to the cloud server, and is received by the control unit from the cloud server.

According to another aspect of the exemplary embodiments, there is provided a method of sharing contents between devices having access to a cloud network, the method including accessing a cloud server by a first device; and controlling networking between user devices having access to the cloud server other than the first device, and a content server having access to the cloud server, by the cloud server, wherein the controlling of networking includes detecting the accessed devices from among devices registered in the cloud server by a device management unit of the cloud server based on context information provided by a context recognition management unit of the cloud server.

According to another aspect of the exemplary embodiments, there is provided a method of sharing contents between devices accessible to a cloud server, the method including controlling access of a first device to the cloud server by an access unit of the first device; and reproducing contents received from a content server by a reproduction unit of the first device, wherein the first device is one of devices registered in the cloud server, and wherein the contents include a list of devices having access to and detected by the cloud server from among the registered devices other than the first device, and information regarding functions provided by the detected devices.

According to another aspect of the exemplary embodiments, there is provided a method of sharing contents between devices accessible to a cloud server, the method including controlling access of a second device to the cloud server and a content server by a control unit of the second device; and reproducing information regarding contents received from the cloud server and the contents received from the content server based on a selection of the second device by a user, by a reproduction unit of the second device, wherein the second device is at least one device selected by the user from among devices registered in and having access to the cloud server, and wherein the information regarding the contents is transmitted from the content server to the cloud server, and is received by the control unit from the cloud server.

According to another aspect of the exemplary embodiments, there is provided a computer readable recording medium having recorded thereon a computer program for executing any of the above methods.

### BRIEF DESCRIPTION OF THE DRAWINGS

The above and other features and advantages of the exemplary embodiments will become more apparent by describing in detail exemplary embodiments thereof with reference to the attached drawings in which:

FIG. 1 is a block diagram of a cloud system according to an aspect of the exemplary embodiments

FIG. 2 is a block diagram of a cloud server according to an aspect of the exemplary embodiments;

FIG. 3 is a diagram showing an example of displaying on a first device a list of detected devices and contents including information regarding functions provided by the detected devices, according to an aspect of the exemplary embodiments;

FIG. 4 is a flowchart of a method of accessing a cloud server from a first device;

FIG. 5 is a diagram showing operations of a first device, a content server, a cloud server, and devices having access to the cloud server;

FIG. 6 is a block diagram of a first device according to an aspect of the exemplary embodiments;

FIG. 7 is a block diagram of a device having access to a cloud server, according to an aspect of the exemplary embodiments;

FIG. 8 is a block diagram of a reproduction unit of a device having access to a cloud server, according to an aspect of the exemplary embodiments;

FIG. 9 is a flowchart of a method of sharing contents between devices having access to a cloud network, according to an aspect of the exemplary embodiments;

FIG. 10 is a flowchart of a method of sharing contents between devices accessible to a cloud server, according to an aspect of the exemplary embodiments; and

FIG. 11 is a flowchart of a method of sharing contents between devices accessible to a cloud server, according to an aspect of the exemplary embodiments.

### DETAILED DESCRIPTION OF THE EXEMPLARY EMBODIMENTS

The attached drawings for illustrating exemplary embodiments are referred to in order to gain an understanding of the exemplary embodiments, the merits thereof, and the objectives accomplished by the implementation of the exemplary embodiments. The exemplary embodiments may, however, be embodied in many different forms and should not be construed as being limited to the embodiments set forth herein; rather, these embodiments are provided so that this disclosure will be thorough and complete, and will fully convey the concept of the exemplary embodiments to one of ordinary skill in the art. Meanwhile, the terminology used herein is for the purpose of describing particular embodiments and is not intended to limit the exemplary embodiments. Like reference numerals in the drawings denote like elements.

In the following description of the exemplary embodiments, a detailed description of known functions and configurations incorporated herein will be omitted when it may make the subject matter of the exemplary embodiments unclear. The terms used in the specification are defined in consideration of functions used in the exemplary embodiments, and can be changed according to the intent or conventionally used methods of clients, operators, and users. Accordingly, definitions of the terms should be understood on the basis of the entire description of the present specification.

As used herein, expressions such as “at least one of,” when preceding a list of elements, modify the entire list of elements and do not modify the individual elements of the list.

There are some conventional technologies for sharing contents on a web page. However, the conventional technologies require a device which reproduces contents, and thus may not allow users to directly share desired contents with the defined device, and do not use context information to share the contents. Also, functions of the device are not used via a device application programming interface (API) to reproduce the contents.

The exemplary embodiments relate to a method and system for using a device previously registered in a cloud network and for transmitting information regarding multimedia contents to be reproduced to the device, in order to share contents based on context information. In order to reproduce the contents desired by a user on the device, the contents may be directly shared with the device in the cloud network. Also, the context information may be used in the device, and functions of the device may be easily executed via a device API.

The exemplary embodiments are not limited to the aforementioned description, and it will be clearly understood by one of ordinary skill in the art based on the following description.

Hereinafter, the exemplary embodiments will be described in detail by explaining the exemplary embodiments with reference to the attached drawings.

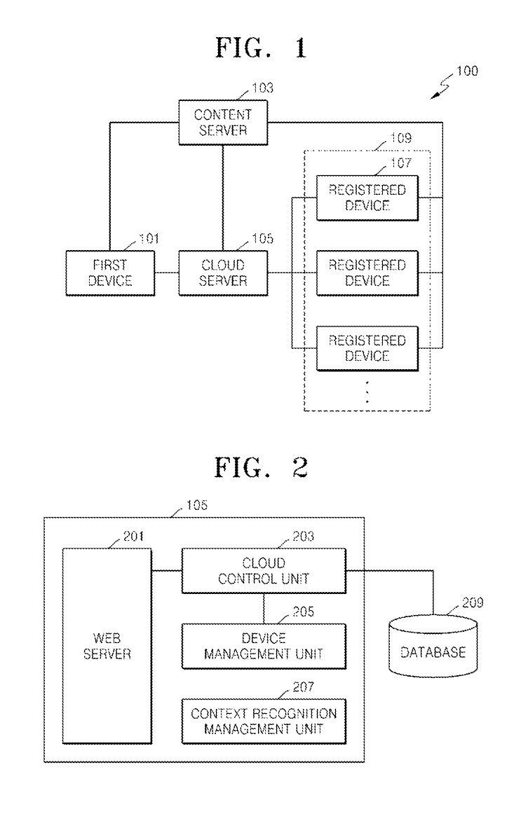

FIG. 1 is a block diagram of a cloud system 100 according to an aspect of the exemplary embodiments. The cloud system 100 includes a cloud server 105, a content server 103 having access to the cloud server 105, a first device 101 having access to the cloud server 105 and the content server 103, and one or more devices 107 previously registered in the cloud server 105. The cloud system 100 may be a portion of a cloud network (not shown) having a complicated structure. Also, the registered devices 107 may form at least one community 109.

FIG. 2 is a block diagram of the cloud server 105 according to an aspect of the exemplary embodiments. The cloud server 105 may include a web server 201 for controlling access from the first device 101; a cloud control unit 203 for controlling networking between the devices 107, previously registered in the cloud server 105, and the content server 103 having access to the cloud server 105; a device management unit 205 for managing information regarding the first device 101 and the registered devices 107; and a context recognition management unit 207 for managing context information regarding the first device 101 and the registered devices 107.

The web server 201 may receive log-in information (e.g., identification (ID) and a password (PW)) from a user and may perform authentication when the first device 101 accesses the cloud server 105. The cloud server 105 performs authentication by matching the log-in information received from the user to log-in information of the user previously registered in a database 209. If the log-in information received from the user does not match the registered log-in information of the user (that is, if the user is not authenticated), the first device 101 may be sent a request for re-authentication. In other words, the cloud server 105 may request the first device 101 for correct log-in information of the user.

If the log-in information received from the user matches the log-in information registered in the database 209 and authentication is successfully performed (that is, if the user is authenticated), the cloud server 105 may transmit a token regarding the user to the first device 101. A token refers to a series of special bitstreams transmitted around a token-ring network, and computers may send a message to a network only when they obtain a token that circulates in the network. Since a network has only one token, two or more computers cannot simultaneously transmit a message.

The cloud control unit 203 may control a network between the content server 103 and the registered devices 107. For example, if a request for context information regarding the registered devices 107 is sent to the cloud server 105 by using a plug-in embedded in a web site for providing multimedia contents to be reproduced upon a request of the first device 101, the cloud control unit 203 may detect one or more devices (hereinafter referred to as accessed devices 108) having access to the cloud server 105 from among the registered devices 107 based on the context information. The cloud control unit 203 may form a list of the detected accessed devices 108 and may transmit the list of the accessed devices 108 to the first device 101 together with contents via the content server 103. That is, the cloud control unit 203 may receive a request for the list of the accessed devices 108 from a script of the content server 103, which is embedded to display a frame or portal on a web site including the list of the accessed devices 108, and may provide the list of the accessed devices 108 to the first device 101.

The device management unit 205 may check access states, IP change states, etc. of the devices 107, may obtain information regarding the latest states of the devices 107, and thus may manage the devices 107.

The context recognition management unit 207 may manage context information regarding the devices 101 and 108 in association with the device management unit 205 by adding, deleting, or updating information regarding the devices 101 and 108. The context information regarding the devices 101 and 108 may include, for example, at least one of the location of the first device 101, the locations of the accessed devices 108, and content reproduction states of the devices 101 and 108, and a preference of the user. Here, the locations of the devices 101 and 108 may include relative location between the devices 101 and 108 within a home network as well as geographical locations of the devices 101 and 108 obtained by using a global positioning system (GPS) or the like. The access states of the devices 101 and 108 may include turn-on or turn-off states of the devices 101 and 108 as well as wire or wireless access states between the devices 101 and 108 and the cloud server 105. The preference of the user may include, for example, the preference for a device frequently used by the user from among the devices 101 and 108, or the preference for a device selected by the user according to the type, genre, index term, or tag of multimedia contents.

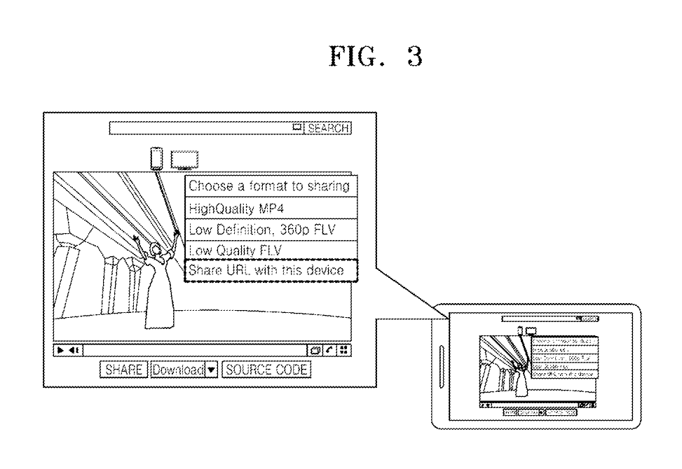

FIG. 3 is a diagram showing an example of displaying on the first device 101 a list of the devices 108 having access to the cloud server 105 and contents including information regarding functions provided by the accessed devices 108, according to an aspect of the exemplary embodiments. The list of the accessed devices 108 may be formed as a grid-type table or freely aligned icons. Also, if a cursor directly clicks or is located on one of the accessed devices 108 of the list, information regarding functions provided by the corresponding accessed device 108 may be displayed. The list of the accessed devices 108 and the information regarding functions provided by the accessed devices 108 may be provided by using a plug-in embedded in a web site for providing multimedia contents to be reproduced by the first device 101. That is, graphic user interfaces (GUIs) such as the icons or buttons may be embedded in a web site in the form of a plug-in that is a program that responds to or is responded to from a host application program and provides a certain ‘on-demand’ function. The form of the plug-in may include a script such as JavaScript.

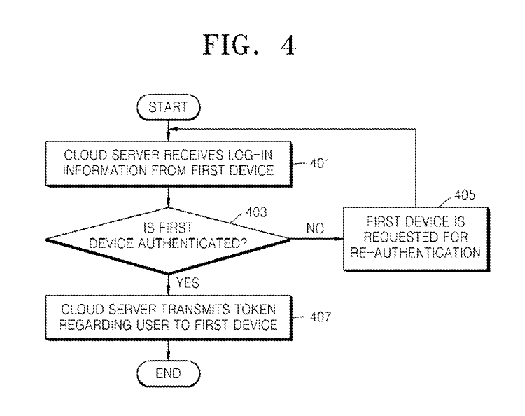

FIG. 4 is a flowchart of a method of accessing the cloud server 105 from the first device 101. In operation 401, the cloud server 105 may receive log-in information from the first device 101. In operation 403, the cloud server 105 may perform authentication. That is, the cloud server 105 performs authentication by matching the log-in information received from the first device 101 to log-in information of a user previously registered in the database 209. If the log-in information received from the first device 101 does not match the registered log-in information of the user (that is, if the user is not authenticated), re-authentication may be requested from the first device 101 (operation 405). In other words, the cloud server 105 may request correct log-in information of the user from the first device 101. On the other hand, if the log-in information received from the first device 101 matches the log-in information registered in the database 209 and thus authentication is successfully performed (that is, if the user is authenticated), the cloud server 105 may transmit a token regarding the user to the first device 101 (operation 407).

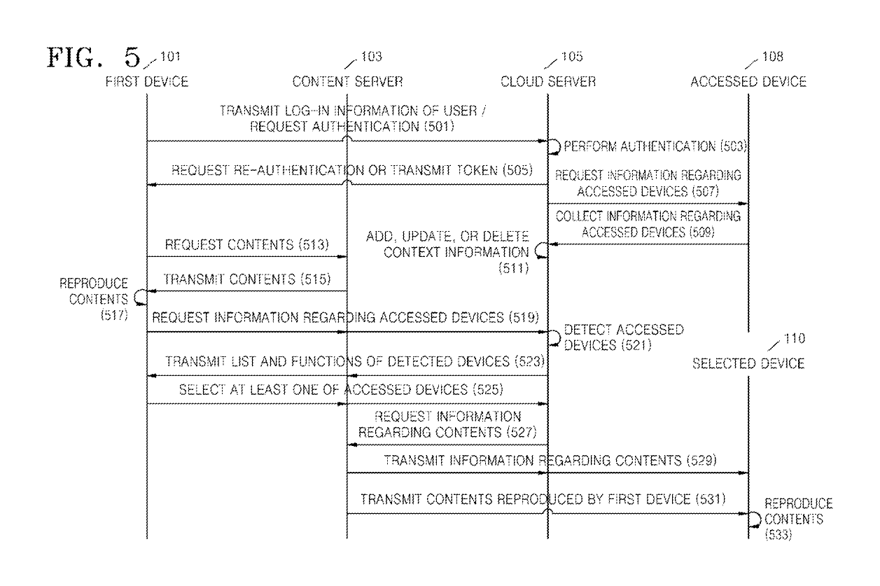

FIG. 5 is a diagram showing operations of the first device 101, the content server 103, the cloud server 105, and the devices 108 having access to the cloud server 105. As described above in relation to FIG. 4, the first device 101 may transmit log-in information of a user to the cloud server 105, and may request authentication from the cloud server 105 (operation 501). The cloud server 105 may perform authentication (operation 503) and may request re-authentication from the first device 101 or may transmit a token to the first device 101 (operation 505).

The cloud server 105 may request information regarding the accessed devices 108 (operation 507). The cloud server 105 may receive the information regarding the accessed devices 108 (operation 509). The cloud server 105 may maintain context information in latest states by adding, updating, or deleting the context information based on the information regarding the accessed devices 108 (operation 511).

The first device 101 may request multimedia contents to be reproduced by the first device 101 from the content server 103 (operation 513), the content server 103 may transmit the multimedia contents to the first device 101 (operation 515), and the first device 101 may reproduce the multimedia contents (operation 517). For example, the first device 101 may visit the content server 103 via a web browser, may select multimedia contents to be reproduced, may request the content server 103 to transmit the selected multimedia contents, and may receive and reproduce the multimedia contents.

If the first device 101 requests a list of the accessed devices 108 and information regarding functions provided by the accessed devices 108 (operation 519), the cloud server 105 may detect the accessed devices 108 from among the devices 107 registered in the cloud server 105 based on the context information (operation 521), and then may transmit the list of the detected accessed devices 108 and the information regarding functions provided by the accessed devices 108 to the first device 101 (operation 523). The list of the accessed devices 108 and the information regarding functions provided by the accessed devices 108 may be requested by executing GUIs, e.g., icons or buttons, provided together with the reproduction-requested multimedia contents. For example, as illustrated in FIG. 3, if a “share” button provided together with multimedia contents reproduced by the first device 101 is clicked to share the multimedia contents, the first device 101 may request the list of the accessed devices 108 and the information regarding functions provided by the accessed devices 108 from the cloud server 105.

A selection signal for selecting one of the accessed devices 108 by the first device 101 may be transmitted to the cloud server 105 (operation 525), and the cloud server 105 may request information regarding contents reproduced by the first device 101 from the content server 103 (operation 527). The content server 103 may transmit the information regarding the contents to the cloud server 105, and the cloud server 105 may receive and transmit the information regarding the contents to the accessed device 108 (operation 529). Also, the content server 103 may directly transmit the contents reproduced by the first device 101 to the accessed device 108 (operation 531). The accessed device 108 may reproduce the received contents (operation 533).

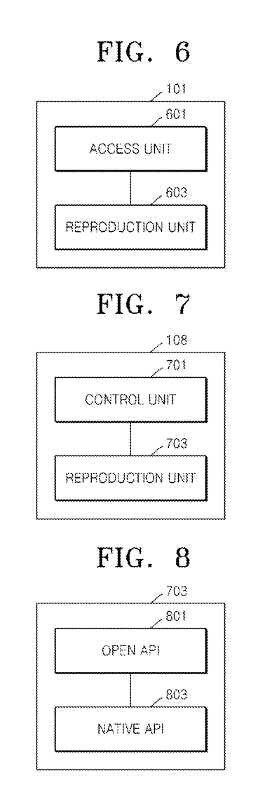

FIG. 6 is a block diagram of the first device 101 according to an aspect of the exemplary embodiments. The first device 101 may be a device for reproducing multimedia contents or may be a device accessible to the cloud server 105. The first device 101 may include an access unit 601 for controlling access to the cloud server 105 and the content server 103; and a reproduction unit 603 for reproducing contents received from the content server 103. The contents may include a list of the devices 108 having access to and detected by the cloud server 105 from among the devices 107 registered in the cloud server 105, and information regarding functions provided by the detected accessed devices 108, and may be received by the access unit 601.

The access unit 601 may access the cloud server 105 via, for example, a web browser. Also, the access unit 601 may receive log-in information from a user, and may transmit the log-in information to the cloud server 105 for authentication. Furthermore, the access unit 601 may receive multimedia contents from the content server 103.

The reproduction unit 603 may reproduce the multimedia contents received from the content server 103. Also, the reproduction unit 603 may display the list of the accessed devices 108 and the information regarding functions provided by the accessed devices 108 together with the multimedia contents, as in FIG. 3.

FIG. 7 is a block diagram of one of the devices 108 having access to the cloud server 105, according to an aspect of the exemplary embodiments.

The accessed device 108 may be a device accessible to the cloud server 105, and may include a control unit 701 for controlling access to the cloud server 105 and the content server 103; and a reproduction unit 703 for reproducing information regarding contents received from the cloud server 105 and the contents received from the content server 103 based on a selection of at least one of the accessed devices 108 by a user. The accessed devices 108 may be devices having access to the cloud server 105 from among the devices 107 registered in the cloud server 105. The information regarding the contents may be transmitted from the content server 103 to the cloud server 105 and may be received by the control unit 701 from the cloud server 105. The control unit 701 may receive, for example, a uniform resource locator (URL) of multimedia contents from the cloud server 105. Also, the control unit 701 may process a representational state transfer (REST) API call to parse and convert a REST call into a platform API call.

FIG. 8 is a block diagram of the reproduction unit 703 of one of the devices 108 having access to the cloud server 105, according to an aspect of the exemplary embodiments.

The reproduction unit 703 may include an open API 801 and a native API 803. The open API 801 may be an interface for increasing openness of a portal, and the native API 803 may be an interface for providing functionality of a device. Multimedia contents received by the control unit 701 may be reproduced via the open API 801 and the native API 803 of the reproduction unit 703.

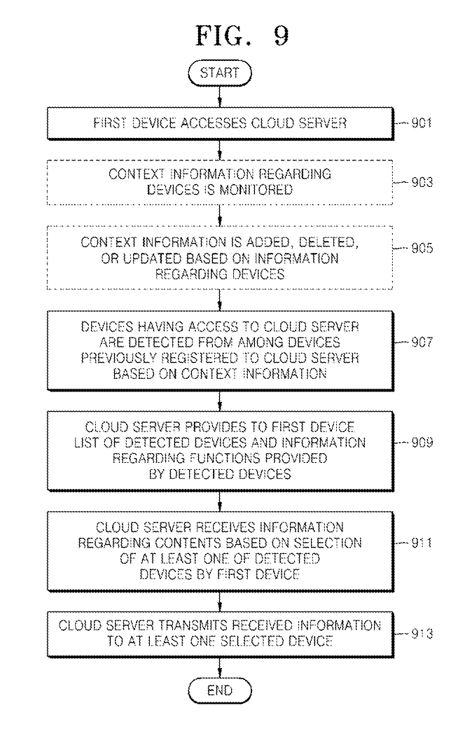

FIG. 9 is a flowchart of a method of sharing contents between the devices 108 having access to a cloud network, according to an aspect of the exemplary embodiments.

In operation 901, the first device 101 may access the cloud server 105. For example, the first device 101 may access the cloud server 105 via a web browser. In operation 903, context information may be monitored. The context information may include at least one of the location of the first device 101, the locations of the devices 107 previously registered in the cloud server 105, and content reproduction states of the devices 101 and 107. In operation 905, the context information in the cloud server 105 may be added, deleted, or updated based on information regarding the devices 101 and 107. Operations 903 and 905 may be periodically performed in a predetermined cycle or may be performed upon a request of a user. Also, operations 903 and 905 may be performed prior to operation 901.

In operation 907, the device management unit 205 of the cloud server 105 may detect the devices 108 having access to the cloud server 105 from among the registered devices 107 based on the context information provided by the context recognition management unit 207 of the cloud server 105.

In operation 909, the cloud server 105 may provide to the first device 101 a list of the accessed devices 108 detected by the cloud server 105 from among the registered devices 107 other than the first device 101, and information regarding functions provided by the accessed devices 108. The information regarding functions provided by the accessed devices 108 may include information regarding whether a high quality MP4, low definition 360P FLV, or low quality FLV file format is supported, or whether a URL is shared.

In operation 911, the cloud server 105 may receive from the content server 103 information regarding contents whose reproduction is requested by the first device 101, based on a selection of at least one of the accessed devices 108 by the first device 101. The information regarding the contents whose reproduction is requested by the first device 101 may include, for example, a URL or a uniform resource identifier (URI) of the contents.

In operation 913, the cloud server 105 may transmit the information regarding the contents to at least one selected device 110. The selected device 110 refers to at least one device selected by the first device 101 from among the accessed devices 108. Also, the selected device 110 may be referred to as a second device. The information regarding the contents transmitted by the cloud server 105 may be transmitted to the selected device 110 in the form of a REST call. For reference, REST is a style of software architecture for distributed hypermedia systems such as the World Wide Web. The term REST is used in the hypertext transfer protocol (HTTP), and refers to a collection of network architecture principles. Here, a network architecture principle refers to a general method of defining resources and designating addresses of the resources, and simply refers to a very simple interface for transmitting domain-oriented data without an additional transmission layer such as session tracking via a simple object access protocol (SOAP) or a cookie over the HTTP. According to a REST architecture form, a very large software system may be designed without using the HTTP and without transmitting data on the World Wide Web. Also, a design is also allowed by using a simple extensible markup language (XML) and an HTTP interface (although they do not comply with the REST principle) instead of using a remote procedure call. A system according to the REST principle is often referred to as a RESTful system.

The devices 101 and 108 may include portable devices such as a desktop, a laptop, an Internet-connectable TV (e.g., an Internet protocol television (IPTV)), a mobile phone, and a smart phone.

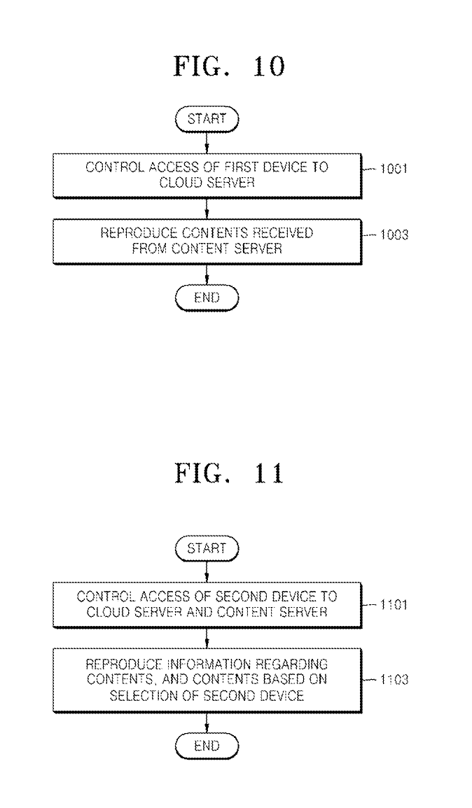

FIG. 10 is a flowchart of a method of sharing contents between the devices 101 and 107 accessible to the cloud server 105, according to an aspect of the exemplary embodiments.

In operation 1001, the access unit 601 of the first device 101 controls access of the first device 101 to the cloud server 105. In operation 1003, the reproduction unit 603 of the first device 101 reproduces contents received from the content server 103. The first device 101 may be one of the devices 107 registered in the cloud server 105. The contents may include a list of the devices 108 having access to and detected by the cloud server 105 from among the registered devices 107 other than the first device 101, and information regarding functions provided by the detected accessed devices 108.

FIG. 11 is a flowchart of a method of sharing contents between the devices 101 and 107 accessible to the cloud server 105, according to an aspect of the exemplary embodiments.

In operation 1101, the control unit 701 of the second device 110 may control access of the second device 110 to the cloud server 105 and the content server 103. The second device 110 may be at least one device selected by a user from among the devices 108 having access to the cloud server 105. In operation 1103, the reproduction unit 703 of the second device 110 may reproduce information regarding contents received from the cloud server 105, and the contents received from the content server 103 based on a selection of the second device 110 by the user. The information regarding the contents may be transmitted from the content server 103 to the cloud server 105, and may be received by the control unit 701 from the cloud server 105.

The exemplary embodiments may be written as computer programs and can be implemented in digital computers that execute the programs using a computer readable recording medium.

Examples of the computer readable recording medium include magnetic storage media (e.g., ROM, floppy disks, hard disks, etc.), optical recording media (e.g., CD-ROMs, or DVDs), etc.

While the exemplary embodiments have been particularly shown and described it will be understood by one of ordinary skill in the art that various changes in form and details may be made therein without departing from the spirit and scope of the inventive concept as defined by the following claims. The exemplary embodiments should be considered in a descriptive sense only and not for purposes of limitation. Therefore, the scope of the exemplary embodiments is defined not by the detailed description of the exemplary embodiments but by the following claims, and all differences within the scope will be construed as being included in the exemplary embodiments.

What is claimed is:

1. A cloud server comprising:
a web server which controls access of a first device to the cloud server;
a cloud control unit which controls networking between devices registered in the cloud server and a content server having access to the cloud server;
a device management unit which manages information regarding the first device and the registered devices; and
a context recognition management unit which manages context information of the first device and the registered devices.

2. The cloud server of claim 1, wherein the web server receives log-in information from the first device, determines whether the first device is authenticated, transmits a token regarding a user to the first device if the first device is authenticated, and requests re-authentication from the first device if the first device is not authenticated.

3. The cloud server of claim 1, wherein the context information comprises at least one of a location of the first device, locations of the registered devices, and content reproduction states of the first device and the registered devices, and wherein the cloud control unit detects devices having access to the cloud server from among the registered devices based on the context information provided by the context recognition management unit.

4. The cloud server of claim 3, wherein the cloud control unit provides a list of the detected devices and information regarding functions provided by the detected devices to the content server such that contents provided by the content server to the first device comprise the list of the detected devices and the information regarding functions provided by the detected devices.

5. The cloud server of claim 4, wherein the cloud control unit receives information regarding contents, whose reproduction is requested by the first device, from the content server, and transmits the received information regarding the contents to at least one of the detected devices based on a selection by the first device.

6. The cloud server of claim 5, wherein the information regarding the contents, whose reproduction is requested by the first device, comprises at least one of a uniform resource locator (URL) and text data of the contents.

7. The cloud server of claim 1, wherein the device management unit adds, deletes, or updates the information regarding the first device and the registered devices, and
wherein the information regarding the first device and the registered devices comprises at least one of addresses and power supply states of the first device and the registered devices.

8. The cloud server of claim 1, wherein the context recognition management unit monitors the context information comprising at least one of a location of the first device, locations of the registered devices, and content reproduction states of the first device and the registered devices.

9. A device accessible to a cloud server, the device comprising:
an access unit which controls access to the cloud server and a content server; and
a reproduction unit which reproduces contents received from the content server,
wherein the accessible device is one of devices registered in the cloud server, and
wherein the contents comprise a list of devices having access to and detected by the cloud server from among the registered devices and information regarding functions provided by the detected devices, and the contents are received by the access unit.

10. The device of claim 9, wherein the access unit selects at least one of the registered devices based on the list of the detected devices and the information regarding functions provided by the detected device, and requests the selected device to perform a predetermined function via the cloud server.

11. The device of claim 9, wherein the access unit receives a token regarding a user from the cloud server if the accessible device is authenticated, and receives a request for re-authentication by the cloud server if the accessible device is not authenticated.

12. A device accessible to a cloud server, the device comprising:
a control unit which controls access to the cloud server and a content server; and
a reproduction unit which reproduces information regarding contents received from the cloud server and the contents received from the content server based on a selection of at least one of devices accessible to the cloud server by a user,
wherein the accessible device is one of devices registered in the cloud server, and
wherein the information regarding the contents is transmitted from the content server to the cloud server, and is received by the control unit from the cloud server.

13. The device of claim 12, wherein the control unit provides information regarding the accessible device to the cloud server upon a request of the cloud server.

14. The device of claim 12, wherein the reproduction unit comprises an open application programming interface (API).

15. The device of claim 14, wherein the reproduction unit further comprises a native API.

16. A method of sharing contents between devices having access to a cloud network, the method comprising:
accessing a cloud server by a first device; and
controlling networking between user devices having access to the cloud server other than the first device, and a content server having access to the cloud server, by the cloud server,
wherein the controlling of networking comprises detecting the accessed devices from among devices registered in the cloud server by a device management unit of the cloud server based on context information provided by a context recognition management unit of the cloud server.

17. The method of claim 16, wherein the accessing of the cloud server by the first device comprises:
receiving log-in information from the first device by the cloud server;
determining whether the first device is authenticated, by the cloud server;
transmitting a token regarding a user to the first device by the cloud server if the first device is authenticated; and
requesting re-authentication from the first device by the cloud server if the first device is not authenticated.

18. The method of claim 16, wherein the controlling of the networking comprises providing a list of the detected devices and information regarding functions provided by the detected devices to the content server, and
wherein the contents provided by the content server to the first device comprise the list of the detected devices and the information regarding functions provided by the detected devices.

19. The method of claim 16, wherein the controlling of networking further comprises:
receiving information regarding contents, whose reproduction is requested by the first device, from the content server by the cloud server based on a selection of at least one of the detected devices by the first device; and
transmitting the received information regarding the contents to the selected device by the cloud server.

20. The method of claim 19, wherein the information regarding the contents whose reproduction is requested by the first device comprises at least one of a uniform resource locator (URL) and text data of the contents.

21. The method of claim 16, wherein the controlling of the networking further comprises adding, deleting, or updating the information regarding the first device and the registered devices, and
wherein the information regarding the first device and the registered devices comprises at least one of addresses and power supply states of the first device and the registered devices.

22. The method of claim 16, wherein the controlling of networking further comprises monitoring the context information comprising at least one of a location of the first device, locations of the registered devices, and content reproduction states of the first device and the registered devices.

23. A method of sharing contents between devices accessible to a cloud server, the method comprising:
controlling access of a first device to the cloud server by an access unit of the first device; and
reproducing contents received from a content server by a reproduction unit of the first device,
wherein the first device is one of devices registered in the cloud server, and
wherein the contents comprise a list of devices having access to and detected by the cloud server from among the registered devices other than the first device, and information regarding functions provided by the detected devices.

24. The method of claim 23, wherein the controlling of access of the first device comprises:
receiving a token regarding a user from the cloud server if the first device is authenticated; and
requesting re-authentication if the first device is not authenticated by the cloud server.

25. A method of sharing contents between devices accessible to a cloud server, the method comprising:
controlling access of a second device to the cloud server and a content server by a control unit of the second device; and
reproducing information regarding contents received from the cloud server and the contents received from the content server based on a selection of the second device by a user, by a reproduction unit of the second device,
wherein the second device is at least one device selected by the user from among devices registered in and having access to the cloud server, and
wherein the information regarding the contents is transmitted from the content server to the cloud server, and is received by the control unit from the cloud server.

26. The method of claim 25, wherein the controlling of access comprises providing information regarding the accessible devices to the cloud server upon a request of the cloud server.

27. The method of claim 25, wherein the reproducing of the information regarding the contents comprises reproducing the information regarding the contents by using an open application programming interface (API).

28. The method of claim 25, wherein the reproducing of the information regarding the contents further comprises reproducing the information regarding the contents by using a native API.

29. A computer readable recording medium having recorded thereon a computer program for executing the method of claim 16.

30. A computer readable recording medium having recorded thereon a computer program for executing the method of claim 23.

31. A computer readable recording medium having recorded thereon a computer program for executing the method of claim 25.

32. A cloud server comprising:
a memory and process operable to control:
a cloud control unit which controls networking between second devices registered in the cloud server and a content server having access to the cloud server; and
a device management unit which manages information regarding a first device accessing the cloud server and the registered second devices.

33. The cloud server of claim 30, further comprising:
a context recognition management unit which manages context information of the first device and the registered second devices.
